(19) United States
(12) Patent Application Publication
(10) Pub. No.: US 2013/0162178 A1
(43) Pub. Date: Jun. 27, 2013

(54) Vibrator

(71) Applicant: Sarah Evans, Long Beach, CA (US)

(72) Inventor: Sarah Evans, Long Beach, CA (US)

(21) Appl. No.: 13/712,841

(22) Filed: Dec. 12, 2012

Related U.S. Application Data
(60) Provisional application No. 61/569,669, filed on Dec. 12, 2011.

(51) Int. Cl. H02P 25/02

(52) U.S. Cl. CPC H02P 25/027
USPC 318/114

(57) ABSTRACT

A vibrator includes a data port for receiving wave patterns and controls for selecting a stored wave pattern. In one embodiment, the vibrator includes two motors each spinning a separate offset weight, providing greater control over vibrations. In some embodiments the wave patterns represent a musical score or song stored in the vibrator and later selected and used to drive the vibrator and/or provide an acoustic output for listening. In some embodiments at least one LED light on the vibrator housing may also be modulated by the selected vibration pattern. In some embodiments the vibrator may also send or receive a wireless digital music signal to either control the acoustic output of a separate sound producing device or to control the mechanical vibrations generated by the vibrator.

### CROSS-REFERENCE TO RELATED APPLICATIONS

The present application Claims the priority of U.S. Provisional Patent Application Ser. No. 61/569,669 filed Dec. 12, 2011, which application is incorporated in its entirety herein by reference.

### BACKGROUND OF THE INVENTION

The present invention relates to vibrators and in particular to vibrators providing programmable vibration patterns.

Known vibrators provide different frequencies and amplitudes of vibrations. The sensations provided by such vibrators often to not suit individual users.

### BRIEF SUMMARY OF THE INVENTION

The present invention addresses the above and other needs by providing a vibrator includes which a data port for receiving wave patterns and controls for selecting a stored wave pattern. The vibrator includes two independently controlled motors each spinning a separate offset weight, providing greater control over vibrations. In some embodiments the wave patterns represent a musical score or song stored in the vibrator and later selected and used to drive the vibrator and/or provide an acoustic output for listening. In some embodiments at least one LED light on the vibrator housing may also be modulated by the selected vibration pattern. In some embodiments the vibrator may also send or receive a wireless digital music signal to either control the acoustic output of a separate sound producing device or to control the mechanical vibrations generated by the vibrator.

In accordance with one aspect of the invention, there is provided a programmable vibrator. The vibrator is driven by loaded and stored wave patterns to generate vibrations matching the wave patterns.

In accordance with another aspect of the invention, there is provided a vibrator including a pair of independently controlled motors spinning a pair of offset weights. The presence of two independently controlled mechanical vibration sources allows more flexibility in the control of vibrations.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a top view of a vibrator according to the present invention.

FIG. 1B is a side view of the vibrator according to the present invention.

FIG. 1C is a bottom view of the vibrator according to the present invention.

FIGS. 2A-2C show a schematic of the vibrator according to the present invention.

FIGS. 3A and 3B are schematics of motor circuits of the vibrator according to the present invention.

FIG. 4A shows a side view of a second embodiment of the vibrator according to the present invention.

FIG. 4B shows a top view of the second embodiment of the vibrator according to the present invention.

FIG. 4C shows a bottom view of the second embodiment of the vibrator according to the present invention.

FIG. 4D shows an end view of the second embodiment of the vibrator according to the present invention.

FIG. 5 shows a cross-sectional view of the second embodiment of the vibrator according to the present invention taken along line 5-5 of FIG. 4B.

FIG. 6A shows a first perspective view of the second embodiment of the vibrator according to the present invention.

FIG. 6B shows a second perspective view of the second embodiment of the vibrator according to the present invention.

FIG. 7 shown an exploded view of the second embodiment of the vibrator according to the present invention.

FIG. 8A shown a side view of the second embodiment of the vibrator according to the present invention with a top of the housing removed.

FIG. 8B shown a top view of the second embodiment of the vibrator according to the present invention with a top of the housing removed with some components hidden to show a motor orientation.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

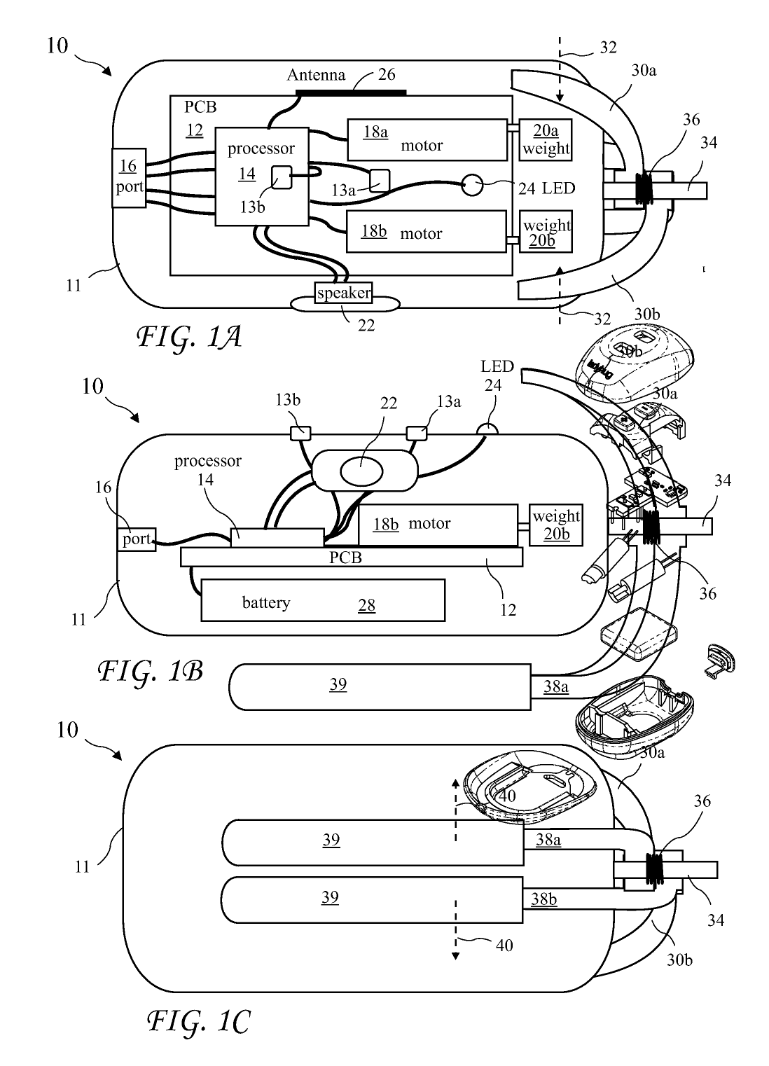

A top view of a vibrator 10 according to the present invention are shown in FIG. 1A, a side view of the vibrator 10 is shown in FIG. 1B, and a bottom view of the vibrator 10 is shown in FIG. 1C. The vibrator 10 includes a housing 11 and a Printed Circuit Board (PCB) 12, with various components attached to the PCB 12. The components include a port 16, up and down control buttons 13a and 13b, a processor 14, two motors 18a and 18b, two offset weights 20a and 20b, and a battery 28. The overall size of the vibrator 10 may be designed for the intended use. The housing 11 is preferably elliptical. The port 16 may be a data port, a power port, or a data and power port. The motors 18a and 18b are preferably independently controlled motors allowing flexibility in the control of vibrations.

Spaced apart arms 30a and 30b residing above the housing 11 and rotate on a shaft 34 extending from the housing opposite the port 16. A spring 36 biases the arms 30a and 30b apart. Legs 38a and 38b attached to the arms 30a and 30b respectively residing under the housing 11 and are biased together by the spring 36. The arms 30a and 30b may be squeezed along arrows 32 to move the legs 38a and 38b apart along arrows 40 and then released allowing, for example, the arm 38a and 38b to grasp a portion of a user's skin to hold the vibrator 10 against the user. Ribbed rubber sleeves 39 over the legs 38a and 38b improve comfort and aid in holding the vibrator 10 in place.

An example of a PCB 12 has an initial thickness of approximately 0.063 inches but may be as thin as 0.02 inches to 0.03 inches. An example of a bare PCB is preferably approximately 0.75 by 1.00 inches.

A user may load various wave patterns using a cable connected to the port 16, for example, using a USB cable connecting the vibrator 10 to a personal computer, or any device capable of storing wave patterns. Wave patterns may further be downloaded from a web site. The wave patterns are stored in the processor 14 for later selection. An example of the processor 14 is capable of producing 17 vibration speeds and four pulsating patterns. The port 16 may, for example, be a USB port or a micro USB port.

The up and down control buttons 13a and 13b control the processor 14. As an example of operation, pressing either button 13a or 13b for at least one half second when vibrator 10 is OFF will turn the vibrator 10 ON to a minimum vibration speed (SPEED 1). Pressing the ‘up’ button 16a will advance to the next higher setting (SPEED 2) and pressing the ‘down’ button 16b will retreat to the next lower speed setting. An example of settings are:
1, 2, 3, 4, 5, 6, 7, 8, 9, 10, 11, 12, 13, 14, 15, 16, 17, A, B, C, D

Where the numbers represent vibration speeds and letters represent programmed vibration wave patterns. When vibrator 10 is ON, pressing either button for at least one half second will turn the vibrator 10 OFF. The buttons 13a and 13b may further provide for software upgrade loading. Simultaneously holding both buttons 13a and 13b for a period of time, for example, for at least four seconds, will put the vibrator 10 into ‘upgrade mode’ where new software may be loaded into vibrator 10 from, for example, any windows based PC using free software available on the Internet.

The motors 18a and 18b may be identical or different and offset weights 20a and 20b may be the same or different. An example of a suitable motor 18a, 18b is model number Z4SL2A0070131 manufactured by Jin Long in China.

The battery 28 is rechargeable through the port and a preferred battery is a rechargeable Lithium Polymer 3.7V 180 mA. The battery size is preferably approximately 21 mm by 21 mm by 5 mm. The battery is recharged through a micro USB connector. The vibrator 10 includes, for example, a charging chip to prevent overcharging, for example, a Li—Po charging chip. Run time is approximately 30 minutes at the highest setting.

In some embodiments the vibrator 10 may further include an acoustic transducer (or speaker) 22, and/or a Light Emitting Diode (LED) 24, and/or an antenna 26.

The speaker 22 may be electrically connected to the processor 14 to received stored music wave patterns to produce an acoustic signal matched to vibrations generated by the motors 18a, 18b and offset weights 20a, 20b.

The LED 24 may be electrically connected to the processor 14 to received an electrical signal to produce luminance matched to vibrations generated by the motors 18a, 18b and offset weights 20a, 20b.

The antenna 26 may electrically connected to the processor 14 to receive an electrical signal to transmit a wireless signal containing the wave pattern selected to control vibrations generated by the motors 18a, 18b and offset weights 20a, 20b. The wireless signal is received by a second device (e.g., a home or personal audio system) to produce an acoustic signal. In another embodiment, the antenna 26 receives a wireless signal from the second device and provides a signal to the processor 14 to generate matching vibrations.

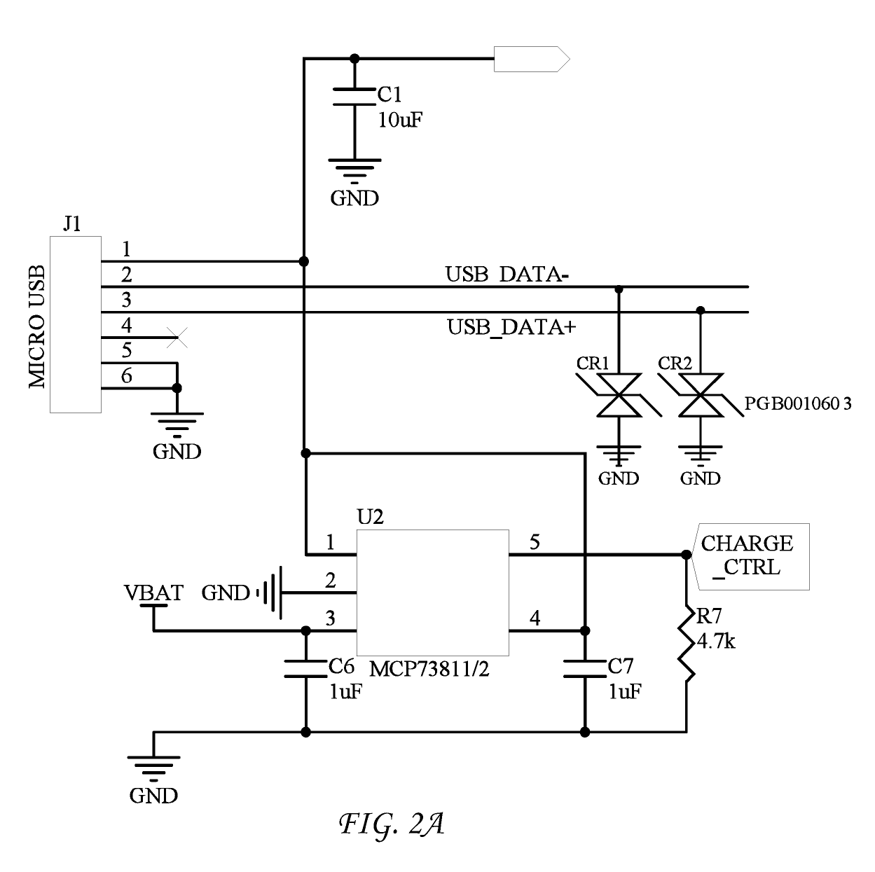

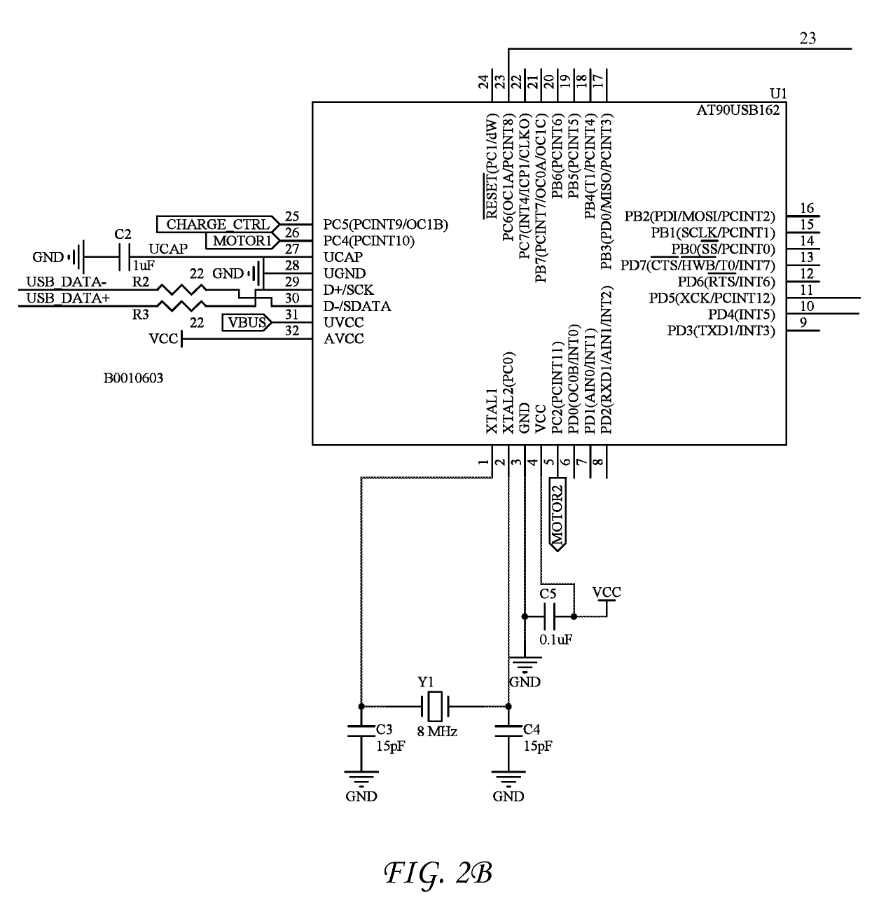

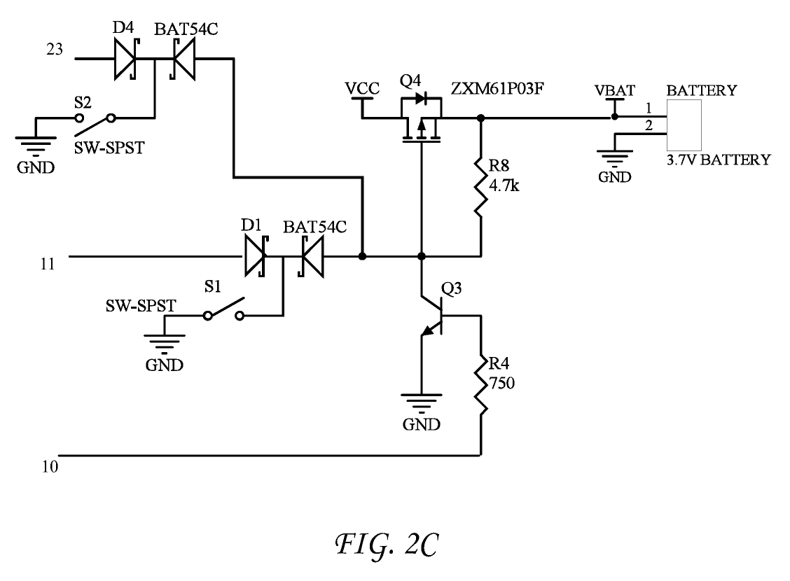

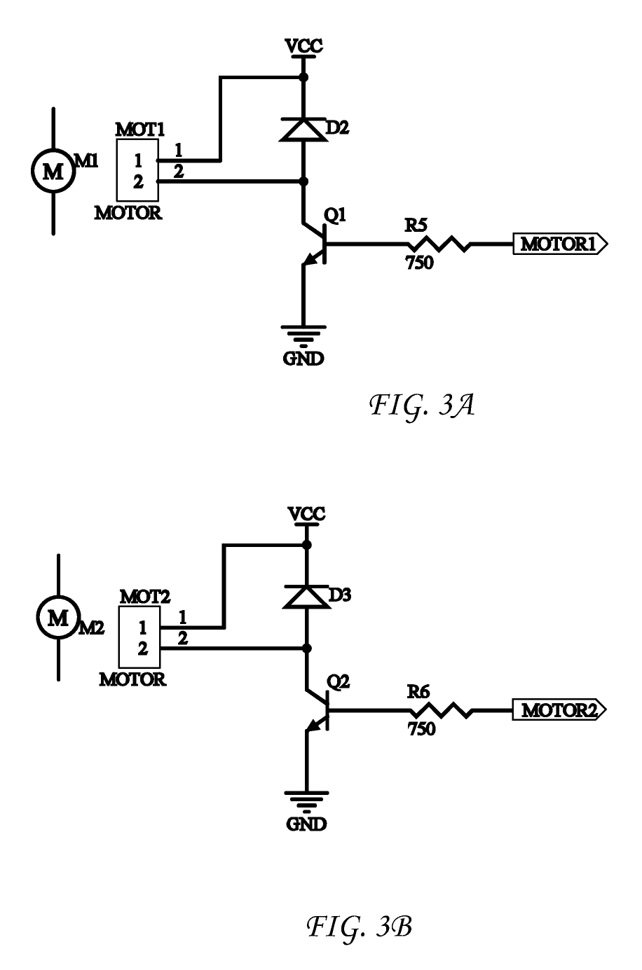

A schematic of an embodiment of the vibrator 10 is shown in FIGS. 2A-2C, and schematics of motor circuits of the vibrator 10 are shown in FIGS. 3A and 3B.

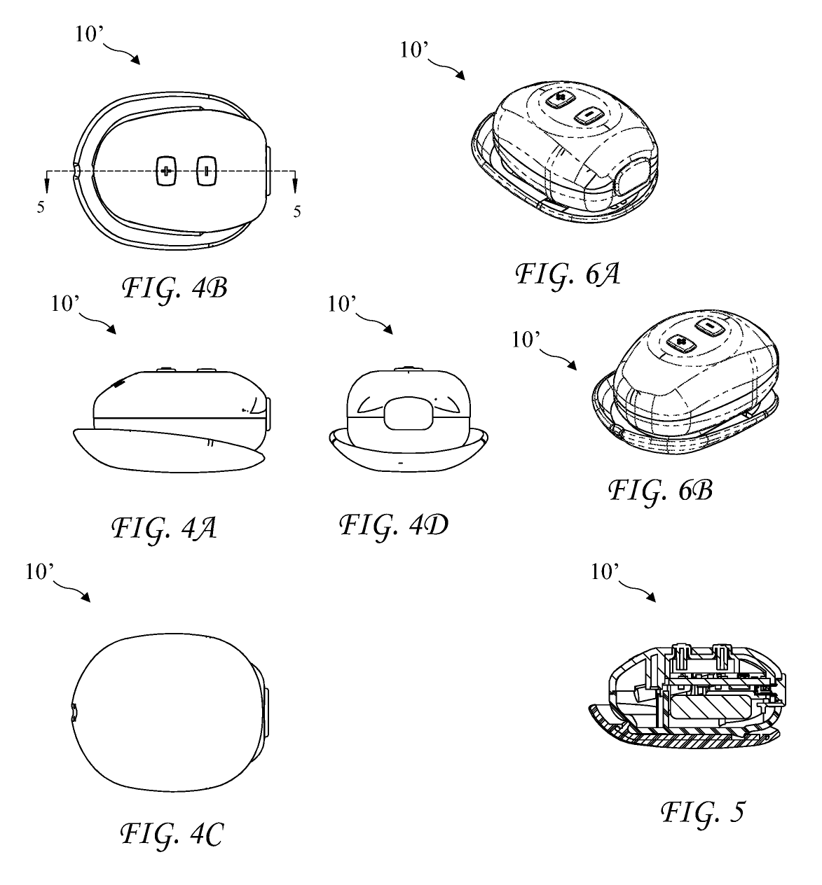

A side view of a second embodiment of the vibrator 10′ is shown in FIG. 4A, a top view of the vibrator 10′ is shown in FIG. 4B, a bottom view of the vibrator 10′ is shown in FIG. 4C, an end view of the second embodiment of the vibrator 10′ is shown in FIG. 4D, and a cross-sectional view of the second embodiment of the vibrator according to the present invention taken along line 5-5 of FIG. 4B.

A first perspective view of the vibrator 10′ is shown in FIG. 6A and a second perspective view of the vibrator 10′ is shown in FIG. 6B.

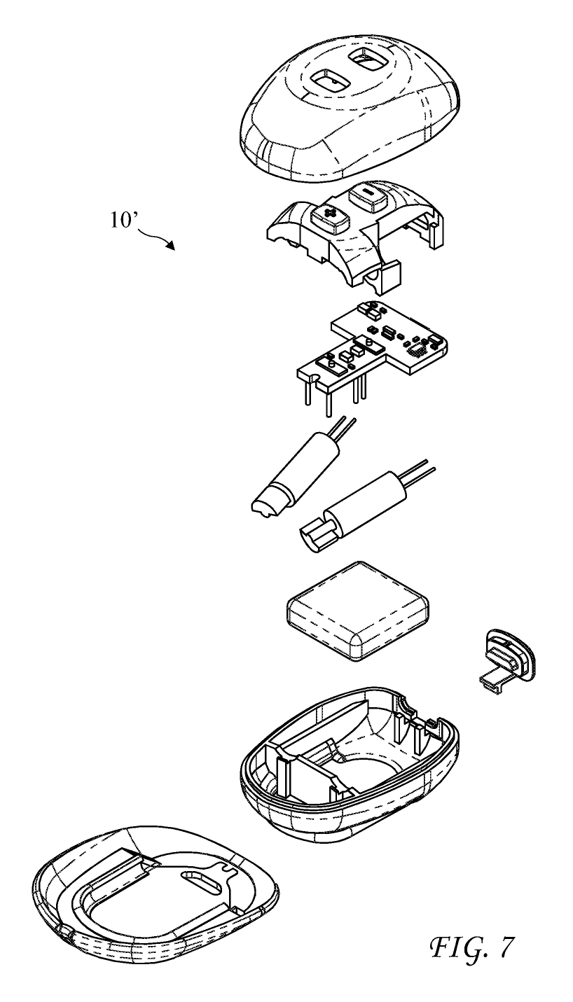

An exploded view of the vibrator 10′ is shown in FIG. 7.

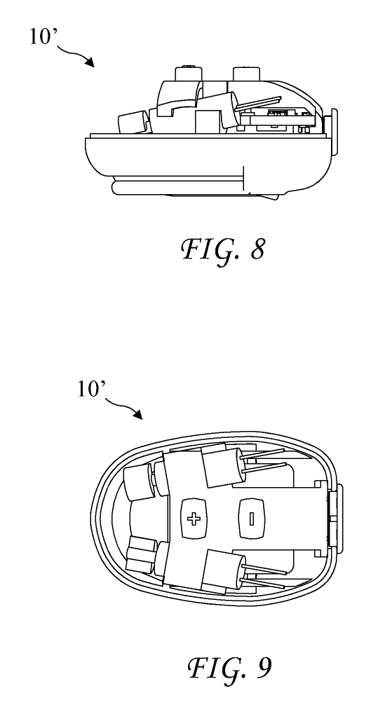

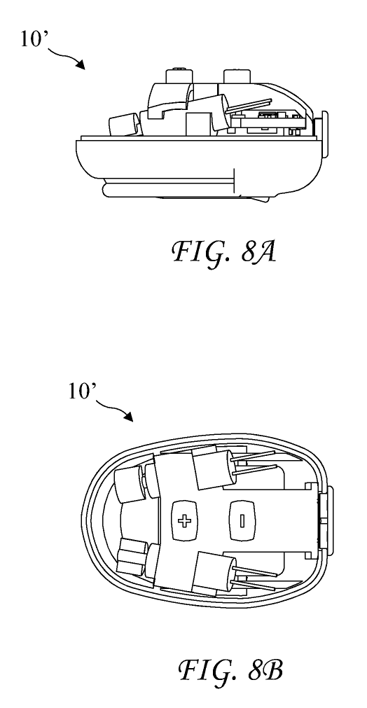

A side view of the vibrator 10′ with a top of the housing removed with some components hidden to show a motor orientation is shown in FIG. 8A and a top view of the vibrator 10′ with the top of the housing removed with some components hidden to show the motor orientation is shown in FIG. 8B.

While the invention herein disclosed has been described by means of specific embodiments and applications thereof, numerous modifications and variations could be made thereto by those skilled in the art without departing from the scope of the invention set forth in the claims.

I claim:

1. A vibrator comprising:
housing;
a Printed Circuit Board (PCB) residing in the housing and including attached components, the components comprising:
a port electrically connected to the PCB;
at least one control electrically connected to the PCB;
a processor receiving signals from the control;
at least two motors;
at least one offset weight rotated by each motor; and
a battery,
wherein wave pattern files are stored in the processor.

2. The vibrator of claim 1, wherein the controls are a pair of up and down control buttons reaching through the housing.

3. The vibrator of claim 1, wherein the two motors are independently controllable for providing flexibility in the control of vibrations.

4. The vibrator of claim 3, wherein the weights have different weight.

5. The vibrator of claim 1, wherein the port is a wired port.

6. The vibrator of claim 5, wherein the wired port is a data port.

7. The vibrator of claim 6, wherein the wired port is a data and power port.

8. The vibrator of claim 1, wherein the port is a wireless port.

9. The vibrator of claim 1, further including an LED electrically connected to the processor, the LED receiving electric signals from the processor to acoustically transmit the stored wave patterns.

10. The vibrator of claim 1, wherein the wave patterns comprise stored music wave patterns and further including a speaker electrically connected to the processor, the speaker receiving electric signals from the processor to acoustically produce the stored music wave patterns.

11. The vibrator of claim 10, further including an antenna electrically connected to the processor and transmitting the stored music wave patterns to a second device, the second device acoustically producing the stored music wave patterns.

12. The vibrator of claim 10, further including an antenna electrically connected to the processor and receiving wireless signals from a second device, the second device acoustically producing the stored music wave patterns and electrically transmitting the stored music wave patterns to the vibrator.

13. The vibrator of claim 1, further including a pair of articulating arms and legs, the arms attached to a pivot point at a first end of the housing and reaching towards the control, one leg fixed to each arm, the legs reaching under the housing opposite to the control, the arms biased apart and the legs biased together, wherein squeezing the arms together opens the legs.

14. A vibrator comprising:
housing;
a Printed Circuit Board (PCB) residing in the housing and including attached components, the components comprising:
a port electrically connected to the PCB;
at least one control electrically connected to the PCB;
a processor receiving signals from the control;
two independently controlled electric motors;
at least one offset weight rotated by each motor; and
a battery; and
wave pattern files stored in the processor and used to control the two electric motors to provide desired vibrations.

15. A vibrator comprising:
housing;
a Printed Circuit Board (PCB) residing in the housing and including attached components, the components comprising:
a port electrically connected to the PCB;
at least one control electrically connected to the PCB;
a processor receiving signals from the control;
two independently controlled electric motors;
at least one offset weight rotated by each motor; and
a battery;
wave pattern files stored in the processor and used to control the two electric motors to provide desired vibrations; and
a pair of articulating arms and legs, the arms attached to a pivot point at a first end of the housing and reaching towards the control, one leg fixed to each arm, the legs reaching under the housing opposite to the control, the arms biased apart and the legs biased together, wherein squeezing the arms together opens the legs.
